(19) United States
(12) Patent Application Publication
(10) Pub. No.: US 2026/0213215 A1
(43) Pub. Date: Jul. 23, 2026

(54) NEGATIVE-ELECTRODE-FREE SECONDARY BATTERY, MODIFIED GRAPHITE, MODIFIED CURRENT COLLECTOR, AND METHOD FOR PREPARING SAME

(71) Applicant: CENTRAL SOUTH UNIVERSITY, Changsha (CN)

(72) Inventors: Haiyan WANG, Changsha (CN); Chunlin Xie, Changsha (CN); Shengfang Liu, Changsha (CN); Hao Wu, Changsha (CN); Qi Zhang, Changsha (CN); Dan Sun, Changsha (CN); Yougen Tang, Changsha (CN)

(21) Appl. No.: 19/452,387

(22) Filed: Jan. 18, 2026

(30) Foreign Application Priority Data
Jan. 17, 2025 (CN) 202510075938.8

(51) Int. Cl. H01M 4/66; H01M 4/02; H01M 10/054

(52) U.S. Cl. CPC H01M 4/667; H01M 4/661; H01M 4/663; H01M 4/668; H01M 10/054; H01M 2004/021

(57) ABSTRACT

The disclosure discloses a negative-electrode-free secondary battery, modified graphite, a modified current collector, and a method for preparing same. The method for preparing the modified graphite includes performing hydrogen-argon mixed gas plasma modification treatment on graphite to prepare the modified graphite. The thickness of the graphite is 20 nm-2 μm, the diameter is 0.1-50 μm, and the degree of graphitization is 80% or more. The power of the hydrogen-argon mixed gas plasma modification treatment is 30-250 W, and the time is 2-25 min. The modification method of the disclosure can alleviate the defects and optimize the structure of the surface of the graphite, thereby constructing physical and chemical characteristics adapted to the negative-electrode-free secondary battery to significantly improve the long cycle life of the negative-electrode-free secondary battery.

### CROSS-REFERENCE TO RELATED APPLICATIONS

The present disclosure claims priority of Chinese Patent Application No. 202510075938.8, filed on Jan. 17, 2025, the entire contents of which are hereby incorporated by reference.

### TECHNICAL FIELD

The disclosure relates to the field of a negative-electrode-free secondary battery, in particular, to the field of negative electrode current collectors of a negative-electrode-free secondary battery.

### BACKGROUND

The main difference between a negative-electrode-free alkali metal secondary battery and a conventional secondary battery with a negative electrode is that there is no active ion embedding material on the negative electrode side, and only negative electrode current collectors or some modified current collectors are provided, so that the working voltage can be increased, and the energy density can be improved. However, there may also be more significant dendrite problems, and the long-range cycle property is difficult to achieve the expectation.

In response to the characteristics of a negative-electrode-free secondary battery, the main solution of the prior art is to optimize and improve current collectors. For example, a Chinese patent document with a publication number CN119213584A discloses a current collector of a negative-electrode-free sodium battery, which is specifically a current collector with a primer coating formed on its surface, where the primer coating includes carbon nanomaterials, and the carbon nanomaterials include at least two of zero-dimensional carbon materials, one-dimensional carbon materials, and two-dimensional carbon materials. A Chinese patent document with a publication number CN119213595A discloses a current collector with an interface protection layer. A Chinese patent document with a publication number CN118398827A discloses a negative electrode current collector of a negative-electrode-free sodium metal battery, including a substrate and a functional coating applied to the surface of the substrate, where the functional coating includes carbon-based materials with different particle sizes and component gradations. For another example, a Chinese patent document with a publication number CN118919734A discloses a negative current collector coated with graphite, carbon nanotubes, and a binder, which is used for a negative-electrode-free sodium metal battery.

In conclusion, there are some reports on carbon coating modification of current collectors of negative-electrode-free batteries in the prior art. However, existing improvement methods are difficult to fundamentally solve the problems of dendrite formation and non-ideal high-current long cycle property in the negative-electrode-free batteries.

### SUMMARY

To solve the problems existing in a negative electrode current collector of a negative-electrode-free secondary battery, the first objective of the disclosure is to provide a method for preparing modified graphite for a negative-electrode-free secondary battery, aiming to prepare modified graphite that can adapt to the application characteristics of the negative-electrode-free secondary battery and can significantly improve the long cycle stability and other properties of negative-electrode-free batteries.

The second objective of the disclosure is to provide modified graphite prepared by the method above.

The third objective of the disclosure is to provide a negative-electrode-free secondary battery including the modified graphite, and a modified current collector thereof.

For current collector materials used for negative-electrode-free secondary batteries, especially for negative-electrode-free sodium metal batteries, researchers mostly achieve highly reversible sodium deposition/stripping by constructing sodium-friendly metal coatings with an alloying ability. However, alloying coatings are relatively high in price and difficult to commercialize, and alloying coatings undergo volume expansion during deposition and stripping processes, leading to coating detachment. Regarding the problems, the disclosure provides the following improvement measures:
in the method for preparing modified graphite for the negative-electrode-free secondary battery, graphite is subjected to hydrogen-argon mixed gas plasma modification treatment to prepare the modified graphite;
the thickness of the graphite is 20 nm-2 μm, the diameter is 0.1-50 μm, and the degree of graphitization is 80% or more; and
the power of the hydrogen-argon mixed gas plasma modification treatment is 30-250 W, and the time is 2-25 min.

The disclosure innovatively selects graphite with specific physical and chemical structural characteristics for performing the hydrogen-argon mixed gas plasma treatment, and further cooperates with the combined control of plasma power and time to achieve the synergistic effect, alleviate the defects and optimize the structure of the surface of the graphite, thereby constructing physical and chemical characteristics adapted to the negative-electrode-free secondary battery, especially negative-electrode-free sodium batteries, for example, constructing structurally-stable alkali metal nucleophilic sites and interfaces to improve electrical conductivity, further reducing the irreversible loss of alkali metals during the use of negative-electrode-free batteries, and optimizing the deposition of alkali metals to significantly improve the long cycle life of negative-electrode-free secondary batteries.

In the disclosure, the synergistic effect of the physical and chemical parameters of the graphite, the plasma type, and the plasma power and time is a key for constructing modified graphite with required physical and chemical characteristics for negative-electrode-free batteries and improving the properties of negative-electrode-free batteries.

Preferably, the thickness of the graphite is 50 nm-500 nm; further preferably, 100 nm-200 nm. The thickness of the graphite follows a normal distribution within the thickness range.

The diameter of the graphite is 0.5 μm-20 μm; and D50 is 2 μm-20 μm, and preferably is 3 μm-15 μm.

The degree of graphitization of the graphite is 85%-95%.

Researches show that under the combined control of the preferred parameters of graphite thickness, diameter (D50), and degree of graphitization, it is helpful to further achieve the synergistic effect and further improve the electrochemical properties of the improved graphite in negative-electrode-free batteries.

In the disclosure, the hydrogen content in the hydrogen-argon mixed gas is 1 vol %-10 vol %, and further may be 3 vol %-6 vol %.

In the disclosure, the power of the hydrogen-argon mixed gas plasma modification treatment is 50-200 W, and further may be 80-120 W. Researches show that under the preferred process, it is helpful to further optimize the physical and chemical structures of the modified graphite to make the modified graphite adapted to the application requirements of negative-electrode-free batteries, thereby being conducive to improving the electrochemical properties of negative-electrode-free batteries.

In the disclosure, the time of the hydrogen-argon mixed gas plasma modification treatment is 3 min-20 min, and is further preferably 5 min-15 min. Researches show that under preferred conditions, it is helpful to further optimize the properties of the prepared modified graphite in negative-electrode-free batteries.

The disclosure further provides a modified current collector for a negative-electrode-free secondary battery, including a conductive substrate and a modified coating compounded on the surface of the conductive substrate. The modified coating includes the modified graphite prepared by the method in the disclosure.

In the disclosure, the modified graphite is used as a modification material of a negative-electrode-free current collector, and the effect of the modified graphite is different from that of a conventional ion battery with a negative electrode. The effect of the modified graphite prepared by the preparation process in negative-electrode-free batteries is not to intercalate or deintercalate sodium, but to regulate the uniformity and reversibility of sodium deposition/stripping in negative-electrode-free sodium batteries.

In the disclosure, the conductive substrate includes a planar foil material or a three-dimensional porous material, and the material includes at least one of copper, aluminum, and titanium.

The modified coating further includes a binder, where the binder includes at least one of polyvinylidene fluoride, carboxymethyl cellulose, styrene butadiene rubber, and polyethylene oxide.

In the modified coating, the content of the modified graphite is 85 wt %-95 wt %.

The thickness of the modified coating is 500 nm-40 μm; preferably 0.5 μm-30 μm, further preferably 5 μm-20 μm, and more preferably 8 μm-15 μm. Researches show that under the preferred thickness, the adaptability of the modified coating to negative-electrode-free batteries can be further improved, which helps to further improve the reversible homogeneous deposition and dissolution of metals in negative-electrode-free current collectors, and helps to further improve the stability thereof.

In the modified current collector of the disclosure, the load capacity of the modified graphite is 0.1 mg/cm²-0.8 mg/cm², and further may be 0.25 mg/cm²-0.5 mg/cm².

The disclosure further provides a method for preparing the modified current collector for a negative-electrode-free secondary battery. Components containing the modified graphite are compounded on the conductive substrate based on a coating process or a printing process to form a modified coating on the substrate, so as to prepare the modified current collector.

The disclosure further provides a negative-electrode-free secondary battery, including the modified graphite in the disclosure. Further, the negative-electrode-free secondary battery includes a positive electrode, a separator, and a current collector, where the current collector is the modified current collector in the disclosure.

The negative-electrode-free secondary battery in the disclosure includes the modified current collector in the disclosure, and other components and structural members may be known. In addition, in the disclosure, the negative-electrode-free secondary battery may further be a negative-electrode-free sodium secondary battery (also known as a negative-electrode-free sodium battery), for which existing methods struggle to overcome property barriers.

### Beneficial Effect

In response to the problems faced by negative-electrode-free secondary batteries, especially a negative-electrode-free sodium battery, the disclosure innovatively provides a method for preparing modified graphite adapted to the physical and chemical characteristics of negative-electrode-free secondary batteries. Based on the physical and chemical characteristics of graphite and the combined treatment of hydrogen-argon mixed gas plasma, and further based on the combined control of treatment power and time, physical and chemical characteristics such as defects, structures, and interfaces adapted to negative-electrode-free secondary batteries can be unexpectedly constructed, thereby optimizing the nucleation, growth, and homogeneous deposition of metals in negative-electrode-free secondary batteries, and further significantly improving the long cycle effect of negative-electrode-free secondary batteries. For example, the negative-electrode-free current collector prepared by the process in the disclosure can circulate for 1000 or more cycles at a high current.

### BRIEF DESCRIPTION OF THE DRAWINGS

FIG. 1A is a scanning electron microscope image of a commercial carbon-coated aluminum foil in Comparative Example 1;

FIG. 1B is a scanning electron microscope image of a composite carbon-coated current collector in Example 1;

FIG. 2 is a cycle stability diagram of a negative-electrode-free sodium battery assembled using a composite current collector in Example 1 at a current density of 300 mA/g; and

FIG. 3 is a cycle stability diagram of a negative-electrode-free sodium battery assembled using a composite current collector in Example 1 at a current density of 200 mA/g.

### DETAILED DESCRIPTION

The technical solution of the disclosure is further described below with reference to examples, but is not limited thereto. Any modification or equivalent substitution of the technical solution of the disclosure without departing from the spirit and scope of the technical solution of the disclosure shall be included in the scope of protection of the disclosure.

### Test Conditions

Preparation of positive electrode plate (NFPP positive electrode): 0.9 g of a positive electrode material of ferric sodium pyrophosphate (NFPP) and 0.05 g of conductive carbon black were weighed and mixed and ground for 30 min, the mixture was then transferred into a weighing bottle, 1 g of a PVDF/NMP (N-methyl pyrrolidone) solution with the PVDF content of 5% was added dropwise, then 1 ml of NMP was added and stirred for 12 h, a carbon-coated aluminum foil was used as a substrate, the mixture obtained by stirring was placed on the substrate and scraped uniformly with a scraper, the product was placed in a vacuum drying box and first dried at 60° C. for 6 h and then dried at 90° C. for 12 h, and the product was taken out and cut into a positive electrode plate (also known as a NFPP positive electrode plate) with a diameter of 12 mm, where the load capacity of the positive electrode material was about 13±1 mg/cm².

Preparation of electrolyte of negative-electrode-free sodium battery: 15.1 g of sodium hexafluorophosphate (NaPF₆) and 0.109 g of NaBF₄ were respectively weighed and dissolved in 100 ml of diethylene glycol dimethyl ether (DEGDME), and 10 g of a molecular sieve was added to absorb some moisture that may remain in DEGDME to obtain a DEGDME electrolyte of 0.9 M NaPF₆+0.1 M NaBF₄. A battery separator was composed of a 19 mm polyethylene separator and a 19 mm glass fiber separator. The above positive electrode, electrolyte and separator as well as the corresponding current collector to be detected were used to assemble a negative-electrode-free sodium battery. The voltage range for testing the negative-electrode-free sodium battery was 1.5-3.9 V, and the test temperature was 30° C.

### Example 1

A graphite flake with a D50 of 3.1 μm was selected, the thickness distribution of the graphite flake was 100-200 nm (particles with a thickness of 150±10 nm account for 50% or more), and the degree of graphitization was 92-93%. The graphite flake was bombarded in the plasma under an argon-hydrogen atmosphere (with a hydrogen content of 5 vol %) at a power of 100 W for 6 min, and then, the treated powder (modified graphite powder) was used to prepare a negative-electrode-free current collector. Steps were as follows:

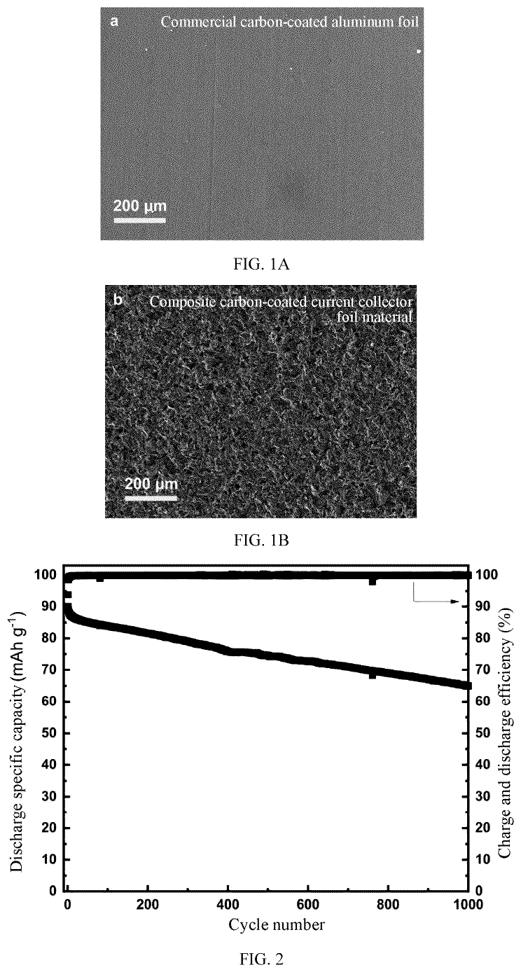

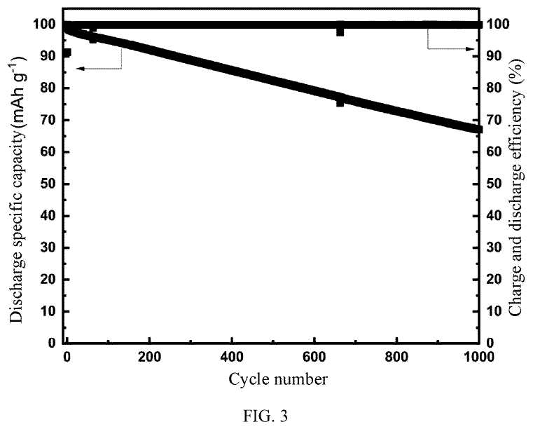

PVDF with the weight accounting for 10% of the weight of the modified graphite powder was used as a binder, dispersed with NMP and then scraped to the surface of the aluminum foil, and subsequently, the product was dried in an oven at 80° C. for 12 h to obtain a modified composite current collector (also known as a carbon-coated current collector), the thickness of the coating was 8 μm, and the load capacity was 0.3 mg/cm² (coated SEM images were shown in FIG. 1A and FIG. 1B). The product was cut into a wafer with a diameter of 14 mm, and then, the wafer was assembled with the prepared NFPP positive electrode and the optimized carbon-coated current collector to obtain a negative-electrode-free sodium battery. The optimized composite current collector was evaluated to obtain results shown in FIG. 2 and FIG. 3. The results show that the use of the modified composite current collector can enable the cycle life of the negative-electrode-free sodium battery to exceed 1000 times at current densities of 300 mA/g and 200 mA/g, where the capacity retention rates for 200 cycles were 90.7% and 92.4% respectively, indicating a significant modification effect.

### Comparative Example 1

The difference from Example 1 was: the following current collectors were used as negative electrode current collectors. Experimental groups were respectively:
Group A: A carbon-coated aluminum foil was used. Compared with Example 1, the only difference was that graphite was not subjected to the hydrogen-argon plasma treatment;
Group B: The negative electrode current collector was an aluminum foil without a modified coating;
Group C: The negative electrode current collector was a copper foil; and
Group D: The negative electrode current collector was a titanium foil.

Each comparative group was cycled according to the method in Example 1 at a current density of 200 mA g⁻¹ at 30° C., and results were shown in Table 1.

TABLE 1

| | | First | Capacity |
|---|---|---|---|
| Experimental | Initial discharge | coulombic | retention rate |
| group | specific capacity | efficiency | after 200 cycles |
| Group A | 95 mAh/g | 87.2% | 60.7% |
| Group B | 85 mAh/g | 78.7% | 21.5% |
| Group C | 87 mAh/g | 80.5% | 27.1% |
| Group D | 86 mAh/g | 79.6% | 31.2% |

According to Table 1, it can be seen that the difference in effect between each comparative group and Example 1 was significant.

### Example 2

The only difference from Example 1 was: the thickness of the graphite before modification was 0.1-0.2 μm (the proportion of the particles with a thickness of 150±10 nm was 50% or more), D50 was 6.5 μm, and the degree of graphitization was 90-91%. The plasma process in Example 1 was used for treatment modification, and a negative-electrode-free current collector was prepared according to the method in Example 1, where the thickness of the modified coating was further improved. Moreover, the assembly was performed according to the method in Example 1 to form a negative-electrode-free battery. Subsequently, a stability test was evaluated by cycling 200 times at a current density of 200 mA/g. Results were shown in Table 2.

TABLE 2

| | Coating | First discharge | First | Capacity |
|---|---|---|---|---|
| | thickness | capacity | coulombic | retention rate |
| Group | (μm) | (mAh/g) | efficiency | after 200 cycles |
| 1-1 | 0.3 | 102.3 | 91.8% | 80.4% |
| 1-2 | 0.5 | 102.1 | 91.7% | 89.7% |
| 1-3 | 15 | 103.1 | 92.3% | 94.8% |
| 1-4 | 30 | 98.2 | 90.1% | 90.5% |
| 1-5 | 50 | 96.7 | 88.7% | 83.1% |

According to Table 2, it can be seen that the thickness of the modified coating was controlled at 0.5-30 μm, preferably controlled at 5-20 μm, and further controlled at 8-15 μm, the properties of the modified coating in negative-electrode-free sodium batteries can be unexpectedly enhanced, and the cycle stability at a high current can be improved.

### Example 3

The only difference from Group 1-3 in Example 2 was: the thickness of the graphite flake was changed, and other operations, parameters, and tests were the same as those in Example 2. Results were shown in Table 3:

TABLE 3

| | | | First | | |
|---|---|---|---|---|---|
| | Distribution of | | discharge | First | Capacity |
| | thickness range of | | capacity | coulombic | retention rate |
| Group | graphite flake | | (mAh/g) | efficiency | after 200 cycles |
| 2-1 | 5-20 | nm | 98.5 | 90.4% | 78.9% |
| 2-2 | 20-50 | nm | 99.1 | 90.9% | 87.2% |
| 2-3 | 50-100 | nm | 101.7 | 91.2% | 90.5% |
| 2-4 | 0.2-0.5 | μm | 102.2 | 91.4% | 90.1% |

Note: The thicknesses of selected graphite flakes follow a normal distribution within the thickness range, where more than half of the graphite flakes were located near the median thickness [(upper limit thickness h1+lower limit thickness h2)/2±10%].

According to Example 2 and Example 3, it can be seen that the thickness of the graphite was controlled, especially, the thickness of the graphite was controlled at 50-500 nm and particularly controlled at 100-200 nm, a better graphite modification effect can be obtained, and better properties of negative-electrode-free sodium batteries can be obtained.

### Example 4

The only difference from Group 1-3 in Example 2 was: the diameter range and D50 of the graphite before modification were changed, and other operations, parameters, and tests were the same as those in Example 2. Results were shown in Table 4:

TABLE 4

| | | | First discharge | First | Capacity |
|---|---|---|---|---|---|
| | D50 of | | capacity | coulombic | retention rate |
| Group | graphite | | (mAh/g) | efficiency | after 200 cycles |
| 3-1 | 50.5 | nm | 97.1 | 88.4% | 80.1% |
| 3-2 | 0.31 | μm | 98.3 | 90.2% | 84.2% |
| 3-3 | 2.1 | μm | 101.7 | 91.1 | 90.9% |
| 3-4 | 14.9 | μm | 102.3 | 91.6% | 91.3% |
| 3-5 | 35.1 | μm | 100.2 | 89.8% | 82.5% |
| 3-6 | 60.6 | μm | 98.1 | 87.6% | 79.1% |

According to Example 2 and Example 4, it can be seen that the particle size of the graphite was controlled, especially, the D50 of the graphite was controlled at 2-20 μm and preferably controlled at 3-15 μm, a better graphite modification effect can be obtained, and better properties of negative-electrode-free sodium batteries can be obtained.

### Example 5

The only difference from Group 1-3 in Example 2 was: the degree of graphitization of the graphite before modification was changed, and other operations, parameters, and tests were the same as those in Example 2. Results were shown in Table 5:

TABLE 5

| | | First discharge | First | Capacity |
|---|---|---|---|---|
| | Degree of | capacity | coulombic | retention rate |
| Group | graphitization | (mAh/g) | efficiency | after 200 cycles |
| 4-1 | 70% | 94.3 | 86.7% | 67.9% |
| 4-2 | 80% | 96.2 | 88.1% | 83.2% |
| 4-3 | 85% | 101.7 | 90.8% | 90.2% |
| 4-4 | 94% | 102.7 | 92.0% | 95.1% |

According to Example 2 and Example 5, it can be seen that the degree of graphitization of the graphite was controlled at 85% or more and preferably controlled at 90% or more, a better graphite modification effect can be obtained, and better properties of negative-electrode-free sodium batteries can be obtained.

### Example 6

The only difference from Group 1-3 in Example 2 lies in hydrogen-argon mixed gas plasma treatment power, and other operations, parameters, and tests were the same as those in Example 2. Results were shown in Table 6:

TABLE 6

| | Treatment | First discharge | First | Capacity |
|---|---|---|---|---|
| | power | capacity | coulombic | retention rate |
| Group | (W) | (mAh/g) | efficiency | after 200 cycles |
| 5-1 | 10 | 96.1 | 87.9% | 75.4% |
| 5-2 | 30 | 97.9 | 89.7% | 84.9% |
| 5-3 | 50 | 98.1 | 88.9% | 88.8% |
| 5-4 | 200 | 100.3 | 90.2% | 89.6% |
| 5-5 | 300 | 93.2 | 85.6% | 79.8% |

According to Example 2 and Example 6, it can be seen that when the treatment power was 50-200 W and preferably 80-120 W, a better graphite modification effect can be obtained, and better properties of negative-electrode-free sodium batteries can be obtained.

### Example 7

The only difference from Group 1-3 in Example 2 lies in hydrogen-argon mixed gas plasma treatment time, and other operations, parameters, and tests were the same as those in Example 2. Results were shown in Table 7:

TABLE 7

| | Treatment | First discharge | First | Capacity |
|---|---|---|---|---|
| | time | capacity | coulombic | retention rate |
| Group | (min) | (mAh/g) | efficiency | after 200 cycles |
| 6-1 | 0 | 98.9 | 88.3% | 74.6% |
| 6-2 | 2 | 99.6 | 89.1% | 83.2% |
| 6-3 | 3 | 100.2 | 89.8% | 86.5% |
| 6-4 | 8 | 103.6 | 92.7% | 92.1% |
| 6-5 | 15 | 101.1 | 91.1% | 92.4% |
| 6-6 | 20 | 100.5 | 90.4% | 87.5% |
| 6-7 | 25 | 97.1 | 87.6% | 80.1% |

According to Example 2 and Example 7, it can be seen that when the treatment time was 3-20 min and preferably 5-15 min, a better graphite modification effect can be obtained, and better properties of negative-electrode-free sodium batteries can be obtained.

### Comparative Example 2

The only difference from Group 1-3 in Example 2 was: the atmospheric atmosphere plasma was changed to oxygen atmosphere plasma, and nitrogen atmosphere plasma, and other operations, parameters, and tests were the same as those in Example 2. Results were shown in Table 8.

TABLE 8

| | | First discharge | First | Capacity |
|---|---|---|---|---|
| | Treatment | capacity | coulombic | retention rate |
| Group | atmosphere | (mAh/g) | efficiency | after 200 cycles |
| 7-1 | Atmospheric | 91.3 | 81.7% | 83.9% |
| | atmosphere | | | |
| 7-2 | Oxygen | 87.2 | 77.6% | 73.2% |
| | atmosphere | | | |
| 7-3 | Nitrogen | 90.8 | 80.2% | 80.5% |
| | atmosphere | | | |

According to Example 2 and Comparative Example 2, it can be seen that the use of the plasma treatment described in the disclosure can unexpectedly achieve the synergistic effect, and can significantly improve the long cycle property of the prepared modified graphite material in negative-electrode-free batteries.

What is claimed is:

1. A modified current collector for a negative-electrode-free secondary battery, comprising a conductive substrate and a modified coating compounded on a surface of the conductive substrate, the modified coating comprising modified graphite;
wherein the modified graphite is prepared by a method comprising: performing hydrogen-argon mixed gas plasma modification treatment on graphite to prepare the modified graphite;
wherein the graphite has a thickness of 20 nm-2 μm, a diameter of 0.1-50 μm, and a degree of graphitization of 80% or more; and
power of the hydrogen-argon mixed gas plasma modification treatment is 30-250 W, and time of the modification treatment is 2-25 min.

2. The modified current collector for a negative-electrode-free secondary battery according to claim 1, wherein the thickness of the graphite is 50-500 nm; the diameter is 0.5-20 μm, and D50 is 2-20 μm; and the degree of graphitization is 85-95%.

3. The modified current collector for a negative-electrode-free secondary battery according to claim 1, wherein a hydrogen content in hydrogen-argon mixed gas is 1-10 vol %.

4. The modified current collector for a negative-electrode-free secondary battery according to claim 1, wherein the power of the hydrogen-argon mixed gas plasma modification treatment is 50-200 W; and the time of the modification treatment is 3-20 min.

5. The modified current collector for a negative-electrode-free secondary battery according to claim 1, wherein the conductive substrate comprises a planar foil material or a three-dimensional porous material, and the material comprises at least one of copper, aluminum, and titanium.

6. The modified current collector for a negative-electrode-free secondary battery according to claim 1, wherein the modified coating further comprises a binder, wherein the binder comprises at least one of polyvinylidene fluoride, carboxymethyl cellulose, styrene butadiene rubber, and polyethylene oxide;
in the modified coating, a content of the modified graphite is 85-95 wt %;
a thickness of the modified coating is 500 nm-40 μm; and
in the modified current collector, a load capacity of the modified graphite is 0.1-0.8 mg/cm².

7. A method for preparing the modified current collector for a negative-electrode-free secondary battery according to claim 1, wherein components containing the modified graphite are compounded on the conductive substrate based on a coating process or a printing process to form the modified coating on the substrate, so as to prepare the modified current collector.

8. A negative-electrode-free secondary battery, comprising a positive electrode, a separator, and a current collector, wherein the current collector is the modified current collector according to claim 1; and
the negative-electrode-free secondary battery is a negative-electrode-free sodium secondary battery.

9. The modified current collector for a negative-electrode-free secondary battery according to claim 2, wherein the conductive substrate comprises a planar foil material or a three-dimensional porous material, and the material comprises at least one of copper, aluminum, and titanium.

10. The modified current collector for a negative-electrode-free secondary battery according to claim 3, wherein the conductive substrate comprises a planar foil material or a three-dimensional porous material, and the material comprises at least one of copper, aluminum, and titanium.

11. The modified current collector for a negative-electrode-free secondary battery according to claim 4, wherein the conductive substrate comprises a planar foil material or a three-dimensional porous material, and the material comprises at least one of copper, aluminum, and titanium.

12. A method for preparing the modified current collector for a negative-electrode-free secondary battery according to claim 2, wherein components containing the modified graphite are compounded on the conductive substrate based on a coating process or a printing process to form the modified coating on the substrate, so as to prepare the modified current collector.

13. A method for preparing the modified current collector for a negative-electrode-free secondary battery according to claim 3, wherein components containing the modified graphite are compounded on the conductive substrate based on a coating process or a printing process to form the modified coating on the substrate, so as to prepare the modified current collector.

14. A method for preparing the modified current collector for a negative-electrode-free secondary battery according to claim 4, wherein components containing the modified graphite are compounded on the conductive substrate based on a coating process or a printing process to form the modified coating on the substrate, so as to prepare the modified current collector.

15. A method for preparing the modified current collector for a negative-electrode-free secondary battery according to claim 5, wherein components containing the modified graphite are compounded on the conductive substrate based on a coating process or a printing process to form the modified coating on the substrate, so as to prepare the modified current collector.

16. A method for preparing the modified current collector for a negative-electrode-free secondary battery according to claim 6, wherein components containing the modified graphite are compounded on the conductive substrate based on a coating process or a printing process to form the modified coating on the substrate, so as to prepare the modified current collector.

17. A negative-electrode-free secondary battery, comprising a positive electrode, a separator, and a current collector, wherein the current collector is the modified current collector according to claim 2; and
the negative-electrode-free secondary battery is a negative-electrode-free sodium secondary battery.

18. A negative-electrode-free secondary battery, comprising a positive electrode, a separator, and a current collector, wherein the current collector is the modified current collector according to claim 3; and
the negative-electrode-free secondary battery is a negative-electrode-free sodium secondary battery.

19. A negative-electrode-free secondary battery, comprising a positive electrode, a separator, and a current collector, wherein the current collector is the modified current collector according to claim 4; and
the negative-electrode-free secondary battery is a negative-electrode-free sodium secondary battery.

20. A negative-electrode-free secondary battery, comprising a positive electrode, a separator, and a current collector, wherein the current collector is the modified current collector according to claim 5; and
the negative-electrode-free secondary battery is a negative-electrode-free sodium secondary battery.
